(19) United States
(12) Patent Application Publication
(10) Pub. No.: US 2005/0269827 A1
(43) Pub. Date: Dec. 8, 2005

(54) Apparatus for lifting of ferromagnetic metal sheets

(76) Inventor: Ian Godfrey Heard, Collaroy Beach (AU)

Correspondence Address: BAY AREA INTELLECTUAL PROPERTY GROUP, LLC, PO BOX 210459, SAN FRANCISCO, CA, 94121-0459, US

(21) Appl. No.: 11/139,756

(22) Filed: May 27, 2005

Related U.S. Application Data
(60) Provisional application No. 60/576,775, filed on Jun. 4, 2004.

(51) Int. Cl. B66C 1/04

(52) U.S. Cl. 294/65.5

(57) ABSTRACT

A relatively lightweight permanent magnetic system employing as integral components on a frame, plate or table, a plurality of shallow field magnetic devices specifically to grip, lift and carry a thin ferromagnetic metal sheet and a means to discharge the retained ferromagnetic metal sheet at will by taking advantage of the propensity of such steel sheet to bend under pressure.

### CROSS-REFERENCE TO RELATED APPLICATIONS

The present Utility patent application claims priority benefit of the U.S. provisional application for patent No. 60/576,775 filed on Jun. 4, 2004 under 35 U.S.C. 119(e).

### FEDERALLY SPONSORED RESEARCH OR DEVELOPMENT

Not applicable.

### REFERENCE TO A SEQUENCE LISTING

Not applicable.

### FIELD OF THE INVENTION

The invention pertains to permanent magnetic lifting devices and specifically to permanent magnetic lifting devices for ferromagnetic sheet, generally larger than that which can be handled manually by one person.

### BACKGROUND OF THE INVENTION

The invention pertains to permanent magnetic lifting devices and specifically to permanent magnetic lifting devices for ferromagnetic sheet, generally larger than that which can be handled manually by one person.

The magnetic handling of single sheets of ferromagnetic steel of thickness of 10 mm (⅜″) or less is difficult, especially if the sheet is large. Such sheet is frequently supplied stacked, and various manual means are employed to first separate and then to lift a sheet from the stack. Manual means may include slings and/or various forms of mechanical sheet grabs. Conventional permanent or electro lifting magnets are generally designed to lift steel of greater thicknesses than those indicated above. In the past, where electromagnets have been used, the number and weight of the magnets required to adequately cover the sheet and to ensure safety, has made the method uneconomic and used more crane or lifting capacity than desirable. Electromagnets typically pick up more than one sheet and the solution has been use of expensive electrical control apparatus.

Vacuum systems have also been employed requiring significant energy and infrastructure machinery.

Permanent magnetic devices employing multiples of shallow, high strength (or high gradient) North-South-North magnetic fields along their length are known and have been used for gripping, dragging and lifting smaller single ferromagnetic steel sheet and other steel work pieces manually. Such devices are limited to the manual handling of relatively small steel items.

In view of the foregoing, there is a need for improved techniques for a permanent magnetic means to lift, carry and release larger ferromagnetic sheets than can be handled manually.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an isometric view of an exemplary frame arrangement with eight multiple-pole, shallow field magnetic assemblies mounted to the frame, in accordance with an embodiment of the present invention;

FIG. 2 illustrates a side view of an exemplary multiple-pole, shallow field magnetic assembly comprising an alternating array of magnetized elements and iron pole pieces, in accordance with an embodiment of the present invention;

FIG. 3 illustrates part of an exemplary frame arrangement with magnetic assemblies mounted to the frame and exemplary pivoted levers with connective linkages, in accordance with an embodiment of the present invention;

FIG. 4 illustrates a side view of an exemplary frame and magnetic assemblies arrangement magnetically holding a ferrous sheet with exemplary pivoted levers flexing a ferrous sheet away from the magnetic assemblies, in accordance with an embodiment of the present invention;

FIG. 5 illustrates an exemplary positive lockdown mechanism used to prevent unintentional activation of the release lever, in accordance with an embodiment of the present invention; and

FIG. 6 illustrates an exemplary isometric view of an exemplary frame arrangement comprising lifting hooks and hollow rectangular sections, in accordance with an embodiment of the present invention.

Unless otherwise indicated illustrations in the figures are not necessarily drawn to scale.

### SUMMARY OF THE INVENTION

To achieve the foregoing and other objects and in accordance with the purpose of the invention, a variety of techniques for the lifting and transportation of ferromagnetic metal sheets are described. In one embodiment, an apparatus is provided that includes magnetic retaining means for retaining the ferromagnetic metal sheet and lifting and carrying means for facilitating the transportation of the ferromagnetic metal sheet. Some embodiments further include means for releasing the ferromagnetic metal sheet from the magnetic retaining means. Such releasing means may include, without limitation, at least one force-imparting mechanical device (e.g., without limitations a lever having a cylindrical roller or wheel at the force-imparting end of the lever that is mechanically actuated manually, pneumatically, hydraulically, electrically, or magnetically) joined to a frame that is operable for imparting a bending force upon the ferromagnetic metal sheet retained by the plurality of permanent magnets, the force being applied at particular points on the ferromagnetic metal sheet to thereby induce a curvature in the ferromagnetic metal sheet that increases the distance between the ferromagnetic metal sheet and at least one of the plurality of permanent magnets.

In another embodiments, a frame is provided that is operable for bearing the load of the ferromagnetic metal sheet, and a plurality of permanent magnets are disposed about the load bearing side of the frame such that the magnets collectively provide adequate force to retain the ferromagnetic metal sheet onto the frame when the frame and the ferromagnetic metal sheet are being transported.

Other features, advantages, and objects of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments.

An aspect of the present invention is to provide a means to lift and to release a single ferromagnetic steel sheet of thickness up to approximately ⅜″ (10 mm). To achieve these objectives, the lifting apparatus employs a number of permanent magnetic assemblies of the multiple pole, shallow field type, or of other types, retained upon a frame or plate, (hereinafter referred to as frame) or other suitable housing arrangement so that an entire ferromagnetic steel sheet may be gripped and lifted at multiple positions minimizing non-supported sheet sag. Further, an aspect of the present invention provides a means to flex the ferromagnetic steel sheet in such a way that it is freed from the attracting force of the magnetic assemblies. Further, some or all of the levers, cams, wheels or other devices to flex the steel sheet away from the magnetic assemblies are linked so as to act solely or in unison. Another aspect of the present invention further provides means to prevent accidental discharge of the magnetically held steel sheet.

Yet another aspect of the present invention provides means to exert pressure on the magnetically retained steel sheet at one or more points outside the interface/s of the magnetic devices and the steel sheet in such a manner as to cause the steel sheet to curve so as to peel away from the magnetic devices, at the discretion of the user. In the present invention, the permanent magnetic lifting device or devices preferably remain stationary and the steel sheet is preferable curved, flexed or distorted in such a manner that it peels from the stationary magnetic device.

The United States standard steel sheet sizes are 8 feet (2438 mm) by 4 feet (1219 mm) and 10 feet (3048 mm) by 5 feet (1524 mm). Even a thin sheet of steel measuring ⅜ inch or less in thickness weighs a considerable amount creating challenges for safe human manipulation. One current method used to handle large sheets is to separate each sheet in a stack by wood shims that allow clearance for forklift forks between each sheet. Additional hazards exist if a sheet should slip off a forklift forks that can cause human and personal property damage. Very large sheets that are also thin may undesirably flex upon human or machine manipulation creating unsafe working conditions, potentially damaging the sheet material, along with creating handling inefficiencies.

The frame, table or plate is provided with means for lifting or lowering by crane, fork-lift or other suitable methods. For certain specialized applications the magnetic devices could be affixed to the top or other surfaces of the frame.

In one embodiment of the present invention, the frame or support device described above is provided integrally with means to impart pressure on the magnetically retained steel sheet at one or more points in such a manner that it is caused to curve or distort so as to introduce an air gap between the steel sheet and the magnetic device at the extremity of one or more of the magnetic devices, causing the steel sheet to peel away from the faces of the aforesaid magnetic devices. The means to move the steel sheet may be mechanical or other means and may embody cams, wheels, levers or springs or a series of cams, wheels, levers, springs or other devices or means such as air or liquid blasts to exert suitable pressure at a point or points on the sheet so that it is caused to curve and to peel from the magnetic devices. The peeling or stripping means may typically operate together by means of linkages but may also be caused to operate singularly or in a desired combination. The peeling or stripping devices may be activated manually or automatically by pneumatic, hydraulic or magnetic actuation or any other suitable means. Also, typically, a fail-safe device will prevent operation of the peeling device during lifting or carrying of a steel sheet.

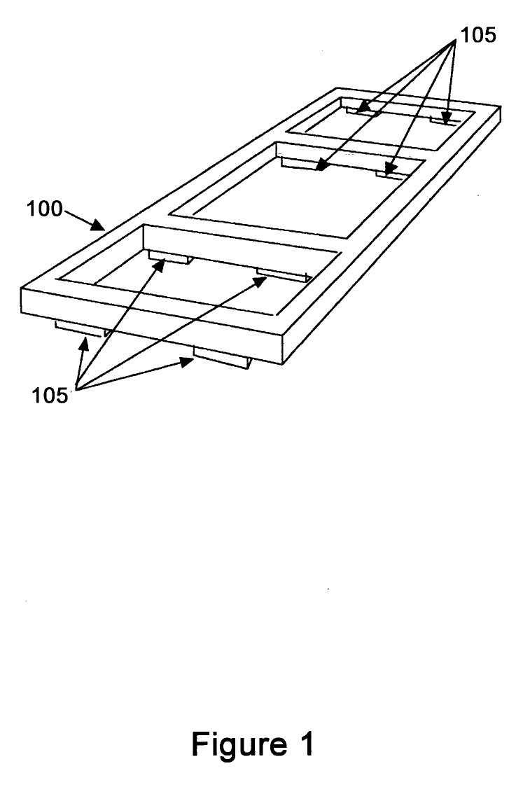

FIG. 1 illustrates an isometric view of an exemplary frame arrangement with eight multiple-pole, shallow field magnetic assemblies mounted to the frame, in accordance with an embodiment of the present invention. The exemplary frame arrangement comprises a suitable frame 100, preferably sized to accommodate any or all standard sizes of ferromagnetic steel sheet. Frame 100 may be made of steel, aluminium or any suitable structural material. Mounted to the underside of frame 100 and at typical points are fixed, preferably threadably or by other suitable means such as clamping or locking devices, a series of magnetic assemblies 105 comprising a plurality of permanent magnets within each assembly. The quantity and strength of magnetic assemblies 105 utilized will be calculated to provide an adequate factor of safety for the weight of sheet to be lifted. Magnetic assemblies 105 are spaced about the length and breadth of frame 100 so as to distribute their ability to lift over the length and breadth of a ferromagnetic sheet to be lifted and are fixed with their magnetic faces downward.

In alternative embodiments of the present invention, the frame or the assemblies of the magnetic devices may be slotted or the magnetic assemblies may be secured within channels or other suitable arrangements so as to provide position adjustments of the magnetic assemblies on the frame.

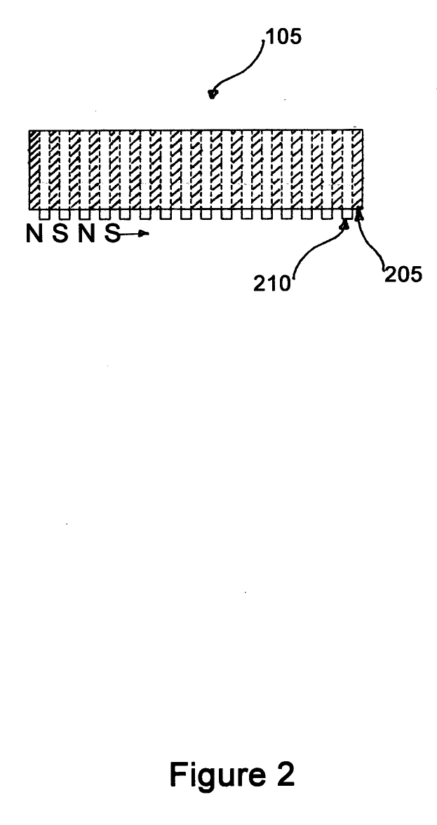

FIG. 2 illustrates a side view of an exemplary multiple-pole, shallow field high strength magnetic assembly comprising an alternating array of magnetized elements and iron pole pieces, in accordance with an embodiment of the present invention. Magnetic assembly 105 comprises a permanent magnet element 205, alternately laminated with a soft iron pole piece 210, and arranged in a series of alternating North-South-North (designated by N, S, N, etc. in FIG. 2) magnetic fields along the length of the series all retained within a housing. Permanent magnet elements 205 will be ferrite, rare earth, alnico or other magnetic material or a combination of any of the above within magnetic assembly 105. The shallow, high strength multiple pole principle allows for a single sheet to be lifted from a stack of ferrous plates or from any other surface.

A magnetizing array with the same magnetizing material within it will be of uniform magnetic strength along its length. A magnetizing array containing a combination of magnetizing materials within a single housing will provide a non-uniform or graduated magnetic strength along its length such as exhibiting a stronger magnetic field in the assembly center, around the periphery, etc.

In an alternative embodiment of the present invention, magnetic assemblies 105 disposed upon frame 100 may each contain a different magnetizing material of any of the above types.

In yet another embodiment, magnetic assemblies of other types and shapes could be used.

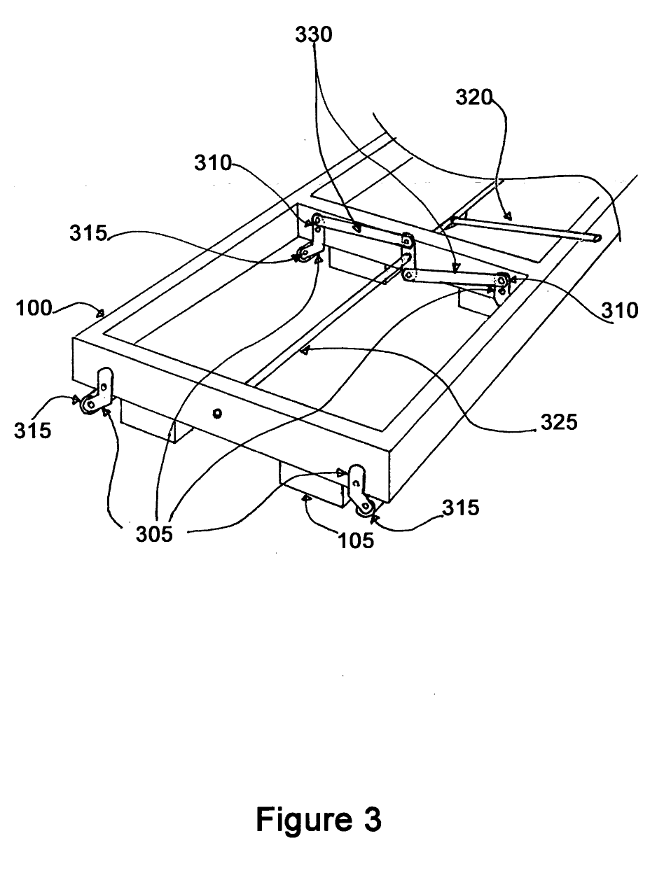

In accordance with an embodiment of the present invention, as shown by way of example in FIG.3, frame 100 has disposed pivotally upon itself, a plurality of lever elements 305, each having a proximal end for actuation 310 and a rotating element 315. Rotating element 315 of each lever element 305 can be a roller mounted on a bearing or bushing or more simply, a radiused contour. Each lever element 305 is pivotally mounted to frame 100 such that movement of a lever arm 320 actuates a connecting linkage 325 which runs substantially the length of frame 100, pivotally connected by a rigid bar or rod, in turn pivoting lever elements 305 about their axis of rotation. Movement of each lever element 305 can be in unison with respect to timing and magnitude of movement or alternately be staggered such that some lever elements 305 pivot at differing times and/or magnitudes with respect to other lever elements.

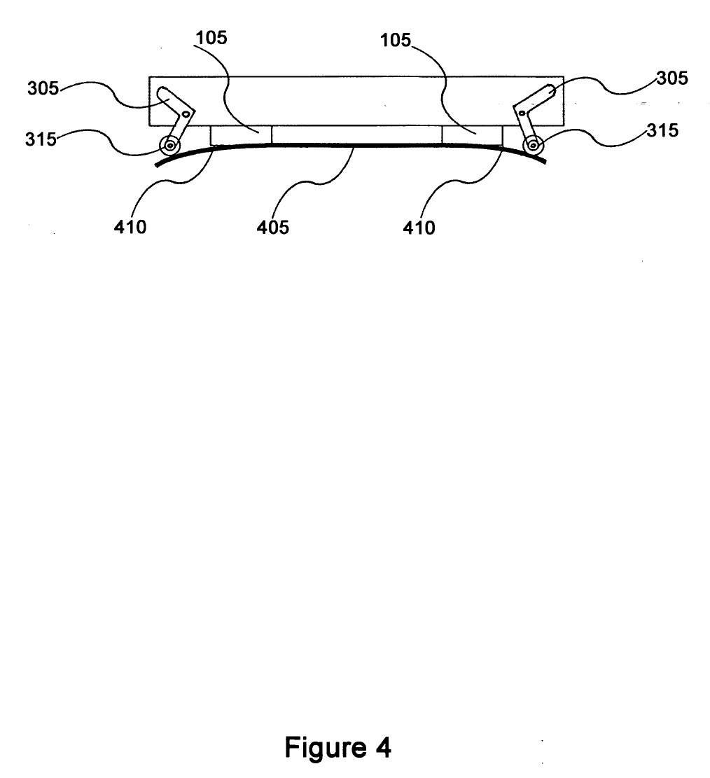

FIG. 4 illustrates a side view of two lever elements 305 pivotally mounted to frame 100, in accordance with an embodiment of the present invention. A ferrous sheet 405 is magnetically retained to magnetic assemblies 105 that are rigidly mounted to frame 100. Lever elements 305 are shown in a partially rotated orientation such that rotating elements 315 are in contact with an outer proximity of ferrous sheet 405. Rotating elements 315 have sufficient travel to locally flex ferrous sheet 405 thus creating a gap 410 between ferrous sheet 405 and magnetic assembly 105. Additional rotation of lever arm 320 (FIG. 3) in turn, rotates operatively connected lever elements 305 thus increasing gap 410 sufficiently to allow ferrous sheet 405 to separate from the magnetic attraction of magnetic assemblies 105 and drop by gravity.

Unlike conventional magnetic lifting devices found that utilize a lever arm to mechanically lift the magnetic assembly from the ferrous plate, the present embodiment relies on the inherent flexibility of ferrous plate 405 to flex away from magnetic assembly 105 when separating ferrous plate 405 from magnetic assemblies 105.

In alternate embodiments of the present invention, lever elements 305 (FIGS. 3-4) may be actuated pneumatically, electrically, hydraulically or by other suitable means creating substantially the same end result.

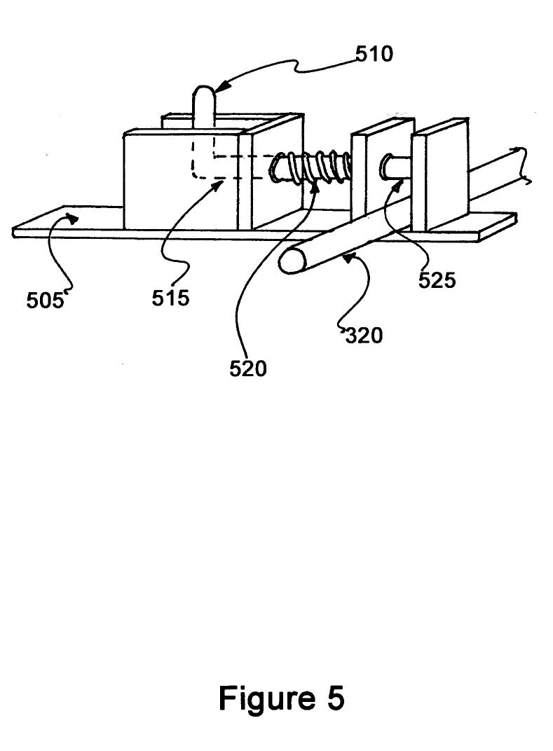

Furthermore, the lifting apparatus is provided with a safety mechanism illustrated in FIG. 5 to prevent unintentional activation of lever arm 320, in accordance with an embodiment of the present invention. There are varieties of available safety mechanisms which may be employed, many available off-the-shelf from hardware distributors. A typical and suitable embodiment illustrated in FIG. 5 comprising a base plate 505 most likely bolted or welded to frame 100 (not shown in FIG. 5), a shaft 510, bent to form a handle at one end, protected by a housing 515 and guided through appropriate holes in plates. Shaft 510 is biased closed by a spring 520 to assume a closed position with shaft 5 10 creating a capture zone 525 for lever arm 320. An operator actuates a ferrous sheet drop by manually sliding shaft 510 against spring 520 through its guide holes allowing lever arm 320 to clear capture zone 525. Then, lever arm 320 is allowed to freely move, carrying with the movement, all operatively connected linkages and lever elements as discussed in FIGS. 3-4.

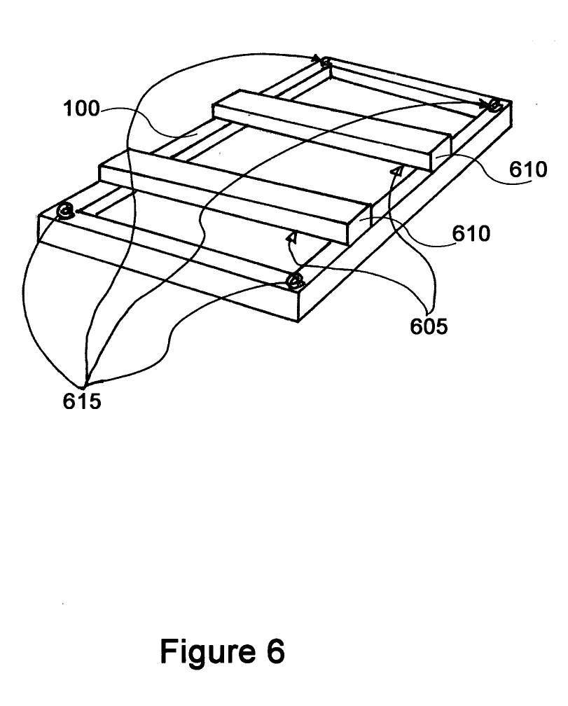

Illustrated in FIG. 6 is frame 100 provided with suitable means for lowering and lifting by forklift, crane or hoist, in accordance with an embodiment of the present invention. Omitted from FIG. 6 for the sake of clarity are all magnetic assemblies and linkage release mechanisms. A pair of parallel rectangular tube elements 605 exhibiting a hollow opening 610 is rigidly connected to frame 100 most likely by a bolted or welded connection. Hollow openings 610 are intended to receive fork-lift lifting forks as are common in nearly any industrial environment. Alternatively, a lift hook 615 or set of hooks provide an additional frame lifting means such as by chain from a forklift, overhead crane. etc.

Having fully described at least one embodiment of the present invention, other equivalent or alternative methods of lifting ferromagnetic metal sheets according to the present invention will be apparent to those skilled in the art. The invention has been described above by way of illustration, and the specific embodiments disclosed are not intended to limit the invention to the particular forms disclosed. The invention is thus to cover all modifications, equivalents, and alternatives falling within the spirit and scope of the following claims.

1. An apparatus for the lifting and transportation of ferromagnetic metal sheets, the apparatus comprising:
magnetic retaining means for retaining the ferromagnetic metal sheet; and
lifting and carrying means for facilitating the transportation of the ferromagnetic metal sheet.

2. The apparatus of claim 1, further comprising means for releasing the ferromagnetic metal sheet from said magnetic retaining means.

3. An apparatus for the lifting and transportation of ferromagnetic metal sheets, the apparatus comprising:
a flame operable for bearing the load of the ferromagnetic metal sheet; and
a plurality of permanent magnets disposed about the load bearing side of said frame, the magnets being configured to collectively provide adequate force to retain the ferromagnetic metal sheet onto said frame when said frame and the ferromagnetic metal sheet are being transported.

4. The apparatus of claim 3, wherein the magnetic poles of said plurality of permanent magnets are arranged in a North-South-North pattern of magnetic fields along the length or breadth of said frame.

5. The apparatus of claim 3, further comprising means for releasing the ferromagnetic metal sheet from said plurality of permanent magnets.

6. The apparatus of claim 3, further comprising at least one force-imparting mechanical device joined to said frame that is operable for imparting a bending force upon the ferromagnetic metal sheet retained by said plurality of permanent magnets, the force being applied at particular points on the ferromagnetic metal sheet to thereby induce a curvature in the ferromagnetic metal sheet that increases the distance between the ferromagnetic metal sheet and at least one of said plurality of permanent magnets.

7. The apparatus of claim 6, wherein said at least one force-imparting mechanical device is selected from the group of force-imparting devices consisting of cams, wheels, levers, offset devices, rods, and springs.

8. The apparatus of claim 6, wherein said at least one force-imparting mechanical device comprises a lever having a cylindrical roller or wheel at the force-imparting end of the lever.

9. The apparatus of claim 6, wherein at least two of said force-imparting mechanical devices are mechanically linked together such that two or more of said force-imparting devices are engaged and disengaged together.

10. The apparatus of claim 6, further comprising means for locking said at least one force-imparting mechanical device into a safety position to prevent engagement during transportation of the retained ferromagnetic metal sheet.

11. The apparatus of claim 6, wherein said at least one force-imparting mechanical device is mechanically actuated pneumatically, hydraulically, electrically, or magnetically.

12. The apparatus of claim 3, wherein said frame is adjustable in length and/or breadth.

13. The apparatus of claim 3, wherein at least one of said plurality of permanent magnets includes a magnetizing material selected from the group consisting of ferrite, rare earth, and alnico magnets.

14. The apparatus of claim 3, wherein at least one of said plurality of permanent magnets is removably joined to said frame.

15. The apparatus of claim 3, wherein the position of at least one of said plurality of permanent magnets is adjustable relative to said frame or relative to any other of said at least one of said plurality of permanent magnets.
